(19) United States
(12) Patent Application Publication
(10) Pub. No.: US 2012/0155928 A1
(43) Pub. Date: Jun. 21, 2012

(54) DEVELOPING DEVICE AND ELECTROPHOTOGRAPHIC IMAGE FORMING APPARATUS EMPLOYING THE SAME

(75) Inventor: Naoya IWATA, Yokohama (JP)

(73) Assignee: Samsung Electronics Co., Ltd., Suwon-si (KR)

(21) Appl. No.: 13/330,074

(22) Filed: Dec. 19, 2011

(30) Foreign Application Priority Data
Dec. 20, 2010 (JP) 2010-283663
Jul. 12, 2011 (KR) 10-2011-0068969

(51) Int. Cl. G03G 15/09

(52) U.S. Cl. 399/274

(57) ABSTRACT

An image forming apparatus including a developing device includes: a housing for housing a developer that includes a carrier and a toner; a development sleeve that is installed rotatably in the housing and is cylindrical and; and a layer regulator installed in the housing in such a way that an end of the layer regulator is spaced apart from an outer circumference surface of the development sleeve, wherein the layer regulator has a stacked structure including a non-magnetic material layer as a substrate, a resin layer for aiding electrifying of the toner by the carrier, and a magnetic material layer for regulating uniformity of the developer. Thus, the developing device is fabricated by using a simple process with sustainable straightness of the layer regulator even when the layer regulator operates and without formation of a step or a space between a magnetic material and a non-magnetic material.

### CROSS-REFERENCE TO RELATED APPLICATIONS

This application claims the priority benefit of Japanese Patent Application No. 2010-283663, filed on Dec. 20, 2010, in the Japanese Patent Office, and Korean Patent Application No. 10-2011-0068969, filed on Jul. 12, 2011, in the Korean Intellectual Property Office, and the disclosures of which are incorporated herein in their entirety by reference.

### BACKGROUND

1. Field

The following description relates to a developing device and an image forming apparatus including the same, and more particularly, to a developing device that develops an electrostatic latent image by using a two-component developer according to an electrophotographic manner and an image forming apparatus including the same.

2. Description of the Related Art

There is a conventional developing device in which a two-component developer that consists of a toner and a carrier is transported to a latent image carrier carrying an electrostatic latent image, and development is performed on a developer carrier. The developing device includes a layer regulator for regulating an amount of the developer on the developer carrier, and the layer regulator is typically formed by attaching a magnetic material to a non-magnetic material that forms a substrate by welding or by using small screws (for example, see JP 2000-98738).

The layer regulator has been developed in consideration of how uniform a thin film formed of the developer is formed on the developer carrier. Also, when the layer regulator is formed, to maintain a uniform layer thickness on the developer carrier, straightness of the layer regulator or the degree of a step or a space between the magnetic material and the non-magnetic material is critical. Also, as described above, when the layer regulator is formed by attaching the magnetic material to the non-magnetic material that forms a substrate by welding or by using a screw, a high level of straightness may not be obtainable due to welding distortion or fastening distortion.

To overcome a decrease in the straightness of the layer regulator occurring due to welding of the magnetic material to the non-magnetic material, as the non-magnetic material that forms a substrate, a thermoplastic resin is used to insert-mold the magnetic material, or only a masking area at an end of the non-magnetic material is coated with a coating material containing a magnetic material (ferrite particle), so as to integrally form the non-magnetic material and the magnetic material as one body (for example, see JP 2006-184451). JP 2006-184451 discloses that the straightness is enhanced by integrally connecting the non-magnetic material to the magnetic material by insert-molding or coating.

As described above, JP 2006-184451 discloses a thermoplastic resin as the non-magnetic material. In this case, the straightness in a non-moving state (that is, when the layer regulator is not operating) may be enhanced. However, when a developer layer on the developer carrier is regulated, due to relatively low rigidity of the thermoplastic resin used as the non-magnetic material, the layer regulator may be warped. Accordingly, such warping of the layer regulator leads to a non-uniform thickness of the developer layer and an image concentration stain in an image.

Also, JP 2006-184451 discloses that a portion of a substrate formed of the non-magnetic material that faces the developing roller is masked and coated with the magnetic material. In this case, however, the number of processes may be substantially increased due to the masking, and furthermore, deterioration with age of a coating agent may cause a decrease in a layer thickness maintenance capability of the developer or mixing of the coating agent separated from the non-magnetic material with the developer. Thus, the leakage results in an image defect when an image is formed.

### SUMMARY

Additional aspects and/or advantages will be set forth in part in the description which follows and, in part, will be apparent from the description, or may be learned by practice of the invention.

An embodiment provides a developing device that is manufactured by using a simple process while straightness of a layer regulator is maintained and a step or a space is not formed between a magnetic material and a non-magnetic material even when the layer regulator is operated, and an image forming apparatus including the developing device.

According to an aspect, there is provided a developing device including: a housing for housing a developer that includes a carrier and a toner; a development sleeve that may be installed rotatably in the housing and may be cylindrical; and a layer regulator installed in the housing in such a way that an end of the layer regulator may be spaced apart from an outer circumference surface of the development sleeve, wherein the layer regulator may have a stacked structure including a non-magnetic material layer as a substrate, a resin layer for aiding electrifying of the toner by the carrier, and a magnetic material layer for regulating uniformity of the developer.

As described above, because the layer regulator includes the resin layer, straightness of the layer regulator during operation of the layer regulator may be maintained and also, a function for aiding toner charging by the carrier may be provided to the layer regulator. Accordingly, an amount of toner that has a relatively low charge level and is scattered outside may be reduced.

The resin layer may include a material used to coat a surface of the carrier. Thus, the same charge amount as that of the carrier may be provided to the toner.

The resin layer may be disposed most upstream among the layers that constitute the layer regulator with respect to a developer transportation direction. Thus, a contact area between the resin layer and toner is widened and thus, greater charge amount may be provided to toner.

The layer regulator may have a three-layer structure including the non-magnetic material layer, the magnetic material layer, and the resin layer sequentially disposed in the order stated from downstream to upstream with respect to the developer transportation direction. Thus, a contact area between the resin layer and toner is widened and also, during the formation of the layer regulator, processability of a pressing process may be improved.

The resin layer may have a thickness that may be equal to or greater than an average particle size of the carrier. Thus, the charging of the carrier by the resin layer may be further ensured.

According to another aspect, there is provided an image forming apparatus including the developing device.

### BRIEF DESCRIPTION OF THE DRAWINGS

The above and other features and advantages will become more apparent by describing in detail exemplary embodiments thereof with reference to the attached drawings in which:

FIG. 1 is a schematic view of an image forming apparatus according to an embodiment;

FIG. 2 is a view of a developing unit included in the image forming apparatus of FIG. 1;

FIG. 3A is a view of an example of a layer regulator included in the developing unit of FIG. 2;

FIG. 3B is a view of another example of the layer regulator included in the developing unit of FIG. 2;

FIG. 3C is a view of another example of the layer regulator included in the developing unit of FIG. 2;

FIG. 4 is a graph of a developer charging amount with respect to a resin layer thickness in the developing unit of FIG. 2; and

FIG. 5 is a graph of a toner scattering amount with respect to a toner/carrier mixture ratio in the developing unit of FIG. 2.

### DETAILED DESCRIPTION

Hereinafter, embodiments will be described in detail with reference to the attached drawings. Also, throughout the present specification and the drawings, constituting elements having substantially identical functional structures are denoted by like reference numerals and thus previously presented description will not be repeatedly presented. Also, in the drawings, sizes and thicknesses of constituting elements may be exaggerated for clarity.

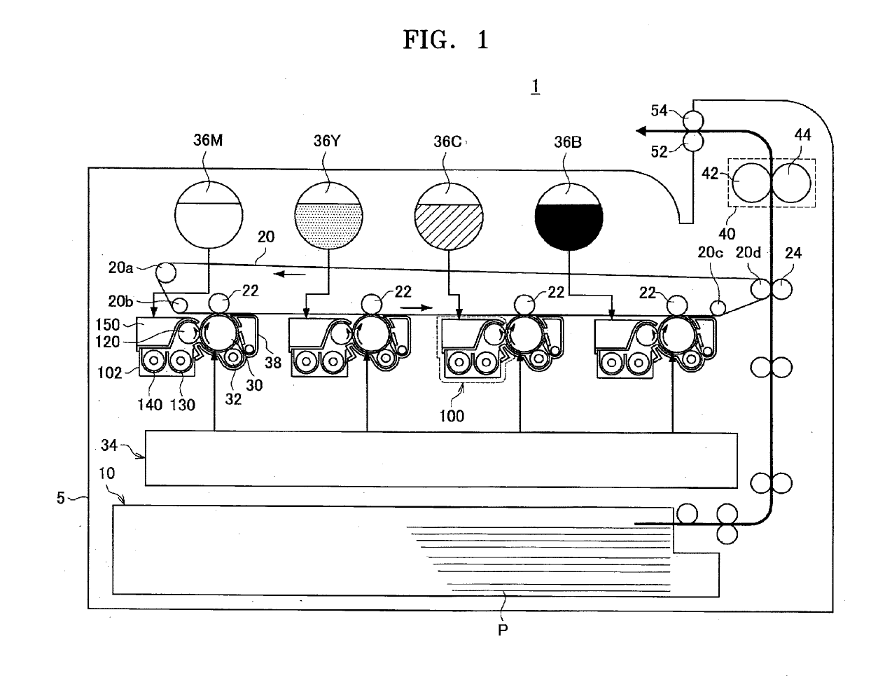

Referring to FIG. 1, a schematic structure and operation of an image forming apparatus 1 including a developing unit 100 as a developing device according to an embodiment will be described in detail. FIG. 1 is a schematic view of the image forming apparatus 1 including the developing unit 100 according to the present embodiment.

The developing unit 100 may be installed in a tandem-type image forming apparatus as illustrated in FIG. 1. The image forming apparatus 1 may include, as illustrated in FIG. 1, a recording medium transportation unit 10, a transfer unit including a transfer belt 20 as an intermediate transfer body, a photo-conducting drum 30 for carrying an electrostatic latent image, the developing unit 100 for developing an electrostatic latent image formed on the photo-conducting drum 30, and a fixing unit 40, which are installed in a case 5.

The recording medium transportation unit 10 houses a recording medium P on which an image is finally formed and transports the recording medium P along a recording medium transportation path. The recording medium P may be, for example, a paper sheet, and may be deposited in a cassette and housed in the recording medium transportation unit 10. The recording medium transportation unit 10 may allow the recording medium P to arrive at a second transfer region at a time when a toner image formed to be transferred onto the recording medium P arrives at the second transfer region.

The transfer unit transports a toner image formed by the developing unit 100, which will be described in detail below, to the second transfer region in which the toner image is second-transferred onto the recording medium P. The transfer unit includes the transfer belt 20, suspension rollers 20a, 20b, 20c, and 20d for suspending the transfer belt 20, a first transfer roller 22 for supporting the transfer belt 20 together with the photo-conducting drum 30, and a second transfer roller 24 for supporting the transfer belt 20 together with the suspension roller 20d.

The transfer belt 20 may be a moving endless belt that circulates on the suspension rollers 20a, 20b, 20c, and 20d. The first transfer roller 22 may be installed compressed against the photo-conducting drum 30 on an inner circumference side of the transfer belt 20. Also, the second transfer roller 24 may be installed compressed against the suspension roller 20d on an outer circumference side of the transfer belt 20. Although not illustrated in FIG. 1, the transfer unit may further include a belt cleaning device for removing toner attached to the transfer belt 20.

The photo-conducting drum 30 may be an electrostatic latent image carrier having an outer circumference surface on which an image is formed, and may include, for example, an organic photo conductor (OPC). The image forming apparatus 1 according to the present embodiment is an apparatus that enables formation of a color image, and may include, for example, four photo-conducting drums 30 corresponding to magenta, yellow, cyan, and black arranged along a rotation direction of the transfer belt 20. Each of the photo-conducting drums 30 is, as illustrated in FIG. 1, surrounded by a charging roller 32, a light exposure unit 34, the developing unit 100, and a cleaning unit 38.

The charging roller 32 uniformly charges a surface of the photo-conducting drum 30 with a predetermined potential. The surface of the photo-conducting drum 30 charged by the charging roller 32 is exposed according to a desired image by the light exposure unit 34. By doing so, a potential of a portion of the surface of the photo-conducting drum 30 that is exposed by the light exposure unit 34 is changed, thereby forming an electrostatic latent image. The developing unit 100 forms a toner image by developing the electrostatic latent image formed on the photo-conducting drum 30 by using a toner supplied from a toner tank (36M, 36Y, 36C, and 36B). A detailed structure of the developing unit 100 will be described in detail below.

The cleaning unit 38 collects a residual toner on the photo-conducting drum 30 after a toner image formed on the photo-conducting drum 30 is first-transferred onto the transfer belt 20. The cleaning unit 38 may be, for example, a cleaning blade, and the cleaning blade may be brought into contact with the outer circumference surface of the photo-conducting drum 30 so as to remove the residual toner remaining on the photo-conducting drum 30. Also, adjacent to the photo-conducting drum 30, an electricity removing lamp (not shown) for resetting a potential of the photo-conducting drum 30 may be installed between the cleaning unit 38 and the charging roller 32 in a rotation direction of the photo-conducting drum 30.

The fixing unit 40 may fix a toner image second-transferred onto the recording medium P from the transfer belt 20 by fusing the toner image on the recording medium P. The fixing unit 40 may include, for example, a heating roller 42 and a compressing roller 44. The heating roller 42 may be a cylindrical element that is rotatable on a rotation axis thereof, and may include, for example, a heating source such as a halogen lamp therein. The compressing roller 44 is a cylindrical element that is rotatable on a rotation axis thereof, and is installed compressed against the heating roller 42. On an outer circumference surface of each of the heating roller 42 and the compressing roller 44, for example, a heat-resistant elastic layer formed of, for example, silicon rubber may be formed. The fixing unit 40 may allow the recording medium P to pass a fixation nip portion that is a contact region of the heating roller 42 and the compressing roller 44 so as to melt-fix the toner image on the recording medium P.

Also, the image forming apparatus 1 includes charge eliminating rollers 52 and 54 for discharging the recording medium P on which a toner image is fixed by the fixing unit 40.

Hereinafter, an operation of the image forming apparatus 1 according to the present embodiment will be described in detail.

When the image forming apparatus 1 begins to operate, an image signal corresponding to an image to be recorded is transmitted to a controller (not shown). Subsequently, the controller may control the charging roller 32 to uniformly electrify the surface of the photo-conducting drum 30 with a predetermined potential and then, based on the received image signal, control the light exposure unit 34 to irradiate light to the surface of the photo-conducting drum 30 to form an electrostatic latent image.

Also, in the developing unit 100, a toner and a carrier, which constitute a developer, are mixed and agitated so as to electrify the toner sufficiently, and then a developing roller 120 carries the developer. When the developer is transported to an area in which the developing roller 120 faces the photo-conducting drum 30 due to rotation of the developing roller 120, the toner from the developer carried by the developing roller 120 is transported onto the outer circumference surface of the photo-conducting drum 30 to form a toner image. In an area in which the photo-conducting drum 30 faces the transfer belt 20, the formed toner image is first-transferred from the photo-conducting drum 30 onto the transfer belt 20. On the transfer belt 20, toner images formed on the four photo-conducting drums 30 are sequentially stacked to form one toner image. The stacked toner image is second-transferred onto the recording medium P transported from the recording medium transportation unit 10 in an area in which the suspension roller 20d faces the second transfer roller 24.

The recording medium P on which a stacked toner image is second-transferred is transported to the fixing unit 40. The recording medium P is allowed to pass between the heating roller 42 and the compressing roller 44 while being exposed to heat and pressure, so that the toner image is melt-fixed on the recording medium P. Thereafter, the recording medium P is discharged outside the image forming apparatus 1 by the charge eliminating rollers 52 and 54. Also, when the transfer belt 20 includes a belt cleaning device, the toner remaining on the transfer belt 20 after the stacked toner image is second-transferred onto the recording medium P is removed by the belt cleaning device.

The tandem-type image forming apparatus 1 illustrated in FIG. 1 is only an example of an image forming apparatus including the developing unit 100 according to the present embodiment. For example, the developing unit 100 according to the present embodiment is used in various types of image forming apparatuses.

Hereinbefore, a schematic structure of the image forming apparatus 1 including the developing unit 100 according to the present embodiment has been described.

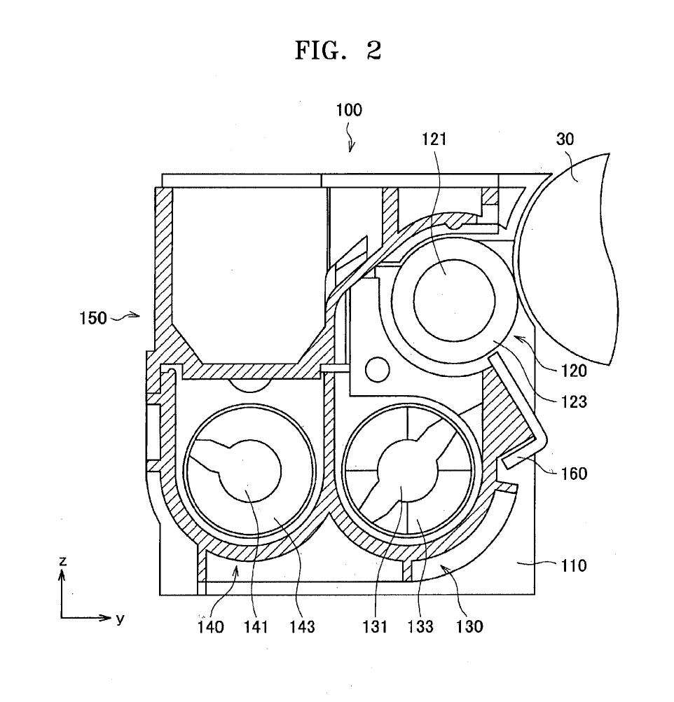

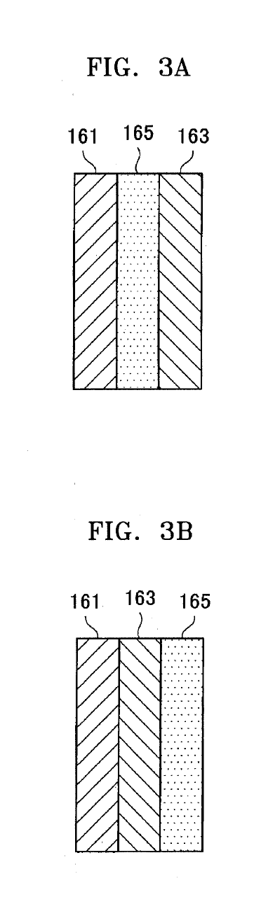

The developing unit 100 according to the present embodiment is characterized in that it includes a layer regulator 160 that easily maintains a level of straightness of the layer regulator 160 even when the layer regulator 160 operates, and helps the developer be electrified. Hereinafter, with reference to FIGS. 2, 3A, 3B, and 3C, a structure of the developing unit 100 and a structure of the layer regulator 160 according to the present embodiment will be described in detail. FIG. 2 is a diagram for explaining the structure of the developing unit 100 according to the present embodiment. FIGS. 3A, 3B, and 3C are diagrams for explaining the structure of the layer regulator 160 according to the present embodiment.

The developing unit 100, as illustrated in FIG. 2, may include a housing 110, the developing roller 120, a first agitation transportation unit 130, a second agitation transportation unit 140 (hereinafter, the first agitation transportation unit 130 and the second agitation transportation unit 140 will also be referred to as an agitation transportation portion), and the layer regulator 160.

The housing 110 is a case for housing the developer (two-component developer), which consists of the toner and the carrier, and for example, the developing roller 120, the first agitation transportation unit 130, the second agitation transportation unit 140, and the layer regulator 160 are installed therein.

The developing roller 120 is a developer carrier for supplying a toner corresponding to an electrostatic latent image formed on the outer circumference surface of the photo-conducting drum 30. The developing roller 120 consists of a development sleeve 123 and a magnet 121 disposed inside the development sleeve 123. The development sleeve 123 is a cylindrical element that is installed rotatably in the housing 110 and is formed of a non-magnetic metal. In the developing roller 120, only the development sleeve 123 rotates and the magnet 121 disposed inside the development sleeve 123 is fixed in the housing 110. Also, the developing roller 120 may include a development bias applier (not shown) that applies a development bias.

The magnet 121 may include a plurality of magnetic poles. For example, different magnetic poles may be alternately disposed in an area in which the magnet 121 faces the photo-conducting drum 30, that is, an area in which an electrostatic latent image formed on the photo-conducting drum 30 is developed, and in an area between the development area and an area in which the magnet 121 faces the first agitation transportation unit 130. This alternating arrangement is to transport the developer over the development sleeve 123 due to a magnetic force. Also, to turn the developer into a magnetic brush so as to bring the magnetic brush in contact with or to be adjacent to the electrostatic latent image of the photo-conducting drum 30, a magnetic pole or a polar interval may be disposed in the development area. Also, in the area in which the developing roller 120 faces the first agitation transportation unit 130, identical magnetic poles may be disposed adjacent to each other along a circumference of the developing roller 120. Due to the identical magnetic poles, at a polar interval, a magnetic force may be relatively low at a corresponding portion of the development sleeve 123 in directions tangent and normal to a rotation direction of the development sleeve 123. Accordingly, the developer may be separated from the development sleeve 123 outside the areas in which the developing roller 120 faces the first agitation transportation unit 130.

The agitation transportation portion is an area in which the carrier as a magnetic material and the toner with no or weak polarity are mixed to electrify the carrier and the toner. The agitation transportation portion includes the first agitation transportation unit 130 and the second agitation transportation unit 140.

The first agitation transportation unit 130 is disposed in a direction roughly perpendicular to the developing roller 120, is disposed facing the developing roller 120, and supplies the mixed developer to the developing roller 120. The first agitation transportation unit 130 includes a first supporting shaft 131 and a first agitation blade 133. The first supporting shaft 131 is installed to be rotatable, with a bearing between the first supporting shaft 131 and an inner wall of the housing 110. The first agitation blade 133 is installed on an outer circumference surface of the first supporting shaft 131 and may include a spiral slanted plane disposed in a lengthwise direction of the first supporting shaft 131.

The second agitation transportation unit 140 sufficiently electrifies the developer by mixing and agitating the developer, and transports the electrified developer to the first agitation transportation unit 130. The second agitation transportation unit 140, like the first agitation transportation unit 130, includes a second supporting shaft 141 and a second agitation blade 143. The second supporting shaft 141 is installed to be rotatable, with a bearing between the second supporting shaft 141 and the inner wall of the housing 110. The second agitation blade 143 is installed on an outer circumference surface of the second supporting shaft 141 and may include a spiral slanted plane disposed in a lengthwise direction of the second supporting shaft 141.

The first agitation transportation unit 130 and the second agitation transportation unit 140 are disposed such that the first supporting shaft 131 and the second supporting shaft 141 are disposed roughly parallel to each other. For example, the first agitation transportation unit 130 and the second agitation transportation unit 140 may be disposed parallel to a horizontal direction (a direction that is roughly perpendicular to a line formed by connecting centers of the developing roller 120 and the first agitation transportation unit 130). A boundary wall 102 (see FIG. 1) may be disposed between the first agitation transportation unit 130 and the second agitation transportation unit 140. The boundary wall 102 may be disposed such that the first agitation transportation unit 130 and the second agitation transportation unit 140 are connected to each other at ends of the first and second agitation transportation units 130 and 140 in such a way that the developer may flow there between.

The developer agitated and transported by the second agitation transportation unit 140 is agitated and transported by the first agitation transportation unit 130 and flows toward an outer circumference surface of the developing roller 120. The second agitation transportation unit 140 may include a toner concentration sensor (not shown) for detecting a toner concentration, and when the toner concentration decreases on a transportation path, the developer may be supplied by the toner tank 36 via a developer supplier 150.

The layer regulator 160 is installed in the housing 110 in such a way that an end of the layer regulator 160 is spaced from an outer circumference surface of the development sleeve 123 upstream from the area in which the developing roller 120 faces the photo-conducting drum 30 with respect to the rotation direction of the development sleeve 123. The layer regulator 160 regulates the developer attached on the outer circumference surface of the development sleeve 123 to make a thickness of the developer uniform. The layer regulator 160 may have a stack structure including a non-magnetic material layer as a substrate, a resin layer, and a magnetic material layer for regulating the thickness uniformity of the developer. The developing unit 100 is characterized in that the layer regulator 160 easily maintains the level of the straightness of the layer regulator 160 even when the layer regulator 160 operates, and helps the developer be electrified. A structure thereof will now be described in detail.

As illustrated in FIGS. 3A, 3B, and 3C, the layer regulator 160 includes a stack structure including a non-magnetic material layer 161 as a substrate, a magnetic material layer 163 for regulating the uniformity of the developer, and a resin layer 165 for aiding the electrification of the toner by the carrier. As described above, the end of the layer regulator 160 is spaced from the outer circumference surface of the development sleeve 123 by a predetermined distance that corresponds to the thickness of the developer on the outer circumference surface of the development sleeve 123. The predetermined distance may be appropriately controlled according to development conditions.

The non-magnetic material layer 161 is a metallic plane formed of a non-magnetic material as a substrate, and may sustain rigidity of the layer regulator 160. A material for forming the non-magnetic material layer 161 may not be limited as long as the material is a non-magnetic material, and examples thereof are an aluminum material and SUS 300-series materials. Also, to maintain the rigidity of the layer regulator 160, the non-magnetic material layer 161 may have a thickness that is greater than that of the magnetic material layer 163, and may be disposed downstream from the magnetic material layer 163 with respect to the rotation direction of the developing roller 120.

The magnetic material layer 163 is a magnetic material plane disposed upstream from the non-magnetic material layer 161 with respect to the rotation direction of the developing roller 120, and may regulate the thickness uniformity of the developer. A material for forming the magnetic material layer 163 may not be limited as long as the material is a magnetic material, and examples thereof are SUS 400-series materials, such as SUS 430.

The resin layer 165 aids the charging of the toner by the carrier due to friction caused by contact between the resin layer 165 and the toner. This is a particular feature of the layer regulator 160 according to the present embodiment. In general, when the two-component developer is used, often, the charging is performed by only the carrier and a charging level of the toner is relatively low. Accordingly, the toner may be insufficiently electrified, may fail to arrive on the outer circumference surface of the development sleeve 123, and thus may be ejected outside the developing unit 100, thereby causing contamination or eroding inside the developing unit 100. However, according to the present embodiment, the layer regulator 160 has a function for aiding the charging of the toner by the carrier due to the resin layer 165 and thus the amount of toner having a relatively low charging level is decreased and the scattering of the toner is suppressed.

The charging property provided by the carrier may be aided by using the same material used to coat a surface of the carrier of the developer to form the resin layer 165. Examples of the coating material for the carrier are acryl resin, styrene resin, styrene-acryl resin copolymer, silicon resin, etc., and the developer according to the present embodiment may be any of various materials that supply a charging property to the toner.

Also, to enhance the aiding function for the charging of the toner by the carrier, the resin layer 165 may have a thickness that is equal to or greater than an average particle size of the carrier of the developer. If the thickness of the resin layer 165 is greater than the average particle size of the carrier, the toner may be sufficiently electrified. Also, the upper limit on the thickness of the resin layer 165 is not particularly restricted. However, if the resin layer 165 is too thick, the thickness of the entire layer regulator 160 is also increased. Thus, processability of the layer regulator 160 with respect to a press process for forming the layer regulator 160 may be lowered. Accordingly, the pressing processability needs to be taken into consideration when the thickness of the resin layer 165 is determined. The average particle size of the carrier according to the present embodiment is measured by laser diffraction.

To form the layer regulator 160, the non-magnetic material layer 161, the magnetic material layer 163, and the resin layer 165 previously described are stacked on each other by using an epoxy resin-based adhesive to form a plane-shape complex material including a plurality of layers, and then pressed to obtain a desired shape. As described above, since the layer regulator 160 is formed by attaching the respective layers to each other to form a complex material and pressing the complex material, the straightness of the layer regulator 160 may be improved without formation of a step or space between a non-magnetic material and a magnetic material. Also, since the respective layers of the composite material are attached to each other by using an adhesive, instead of welding, which is conventionally used, a metal that forms the non-magnetic material layer 161 or the magnetic material layer 163 is able to be attached to a resin that forms the resin layer 165, thereby enabling supplying of the charging aiding function with respect to the developer to the resin layer 165 of the layer regulator 160. As described above, the layer regulator 160 may supply the charging aiding function with respect to the developer while maintaining its straightness. Also, the layer regulator 160 may be processed to be L-shaped to secure rigidity thereof. However, according to the present embodiment, any desired shape may be easily obtainable by simply pressing the stacked composite material.

In the layer regulator 160, an arrangement order of the non-magnetic material layer 161, the magnetic material layer 163, and the resin layer 165 is not limited except that the non-magnetic material layer 161 as a substrate is disposed most downstream among the layers with respect to the rotation direction of the developing roller 120, that is, most downstream among the layers with respect to a developer transportation direction.

For example, as illustrated in FIG. 3A, the non-magnetic material layer 161 may be disposed most downstream among the layers with respect to the developer transportation direction, the resin layer 165 may be disposed on upstream from the non-magnetic material layer 161 with respect to the developer transportation direction, and the magnetic material layer 163 may be disposed upstream from the resin layer 165 with respect to the developer transportation direction. That is, the layer regulator 160 has a three-layer structure including the non-magnetic material layer 161, the resin layer 165, and the magnetic material layer 163, which are sequentially disposed in the order stated from downstream to upstream with respect to the developer transportation direction.

Alternatively, as illustrated in FIG. 3B, the non-magnetic material layer 161 may be disposed on most downstream among the layers with respect to the developer transportation direction, the magnetic material layer 163 may be disposed upstream from the non-magnetic material layer 161 with respect to the developer transportation direction, and the resin layer 165 may be disposed upstream from the magnetic material layer 163 with respect to the developer transportation direction. That is, the layer regulator 160 has a three-layer structure including the non-magnetic material layer 161, the magnetic material layer 163, and the resin layer 165, which are sequentially disposed in the order stated from downstream to upstream with respect to the developer transportation direction.

Alternatively, as illustrated in FIG. 3C, the non-magnetic material layer 161 may be disposed on most downstream among the layers with respect to the developer transportation direction, the resin layer 165 may be disposed upstream from the non-magnetic material layer 161 with respect to the developer transportation direction, the magnetic material layer 163 may be disposed upstream from the resin layer 165 with respect to the developer transportation direction, and furthermore, the resin layer 165 may be disposed upstream from the magnetic material layer 163 with respect to the developer transportation direction. That is, the layer regulator 160 has a four-layer structure including the non-magnetic material layer 161, the resin layer 165, the magnetic material layer 163, and the resin layer 165, which are sequentially disposed in the order stated from downstream to upstream with respect to the developer transportation direction.

As described above, these layer arrangements all contribute to the function of the layer regulator 160 according to the present embodiment. To further enhance the charging aiding function of the resin layer 165, as illustrated in FIGS. 3B and 3C, the resin layer 165 may be disposed most upstream among the layers with respect to the developer transportation direction. Due to the most upstream location of the resin layer 165 with respect to the developer transportation direction, a contact area between the resin layer 165 and the toner is increased compared to the arrangement illustrated in FIG. 3A and the friction charging effect may be improved.

Also, in consideration of the pressing processability during the formation of the layer regulator 160, as illustrated in FIG. 3B, the layer regulator 160 may have the three-layer structure including the non-magnetic material layer 161, the magnetic material layer 163, and the resin layer 165, which are sequentially disposed in the order stated from downstream to upstream with respect to the developer transportation direction. As illustrated in FIG. 3C, if the layer regulator 160 has a four or more-layer structure, the whole thickness of the layer regulator 160 may increase. Thus, the pressing processability may slightly decrease, compared to the case with the three-layer structure illustrated in FIG. 3B.

Typically, a layer regulator is developed to stably regulate only a thickness of a developer layer on a development sleeve. However, the layer regulator 160 according to the present embodiment has the charging aiding function with respect to the developer, which is a major function of the layer regulator 160, as well as the uniform layer thickness regulation characteristic. Accordingly, the amount of toner with a relatively low charging level ejected outside the developing unit 100 and contamination inside the developing unit 100 may be reduced.

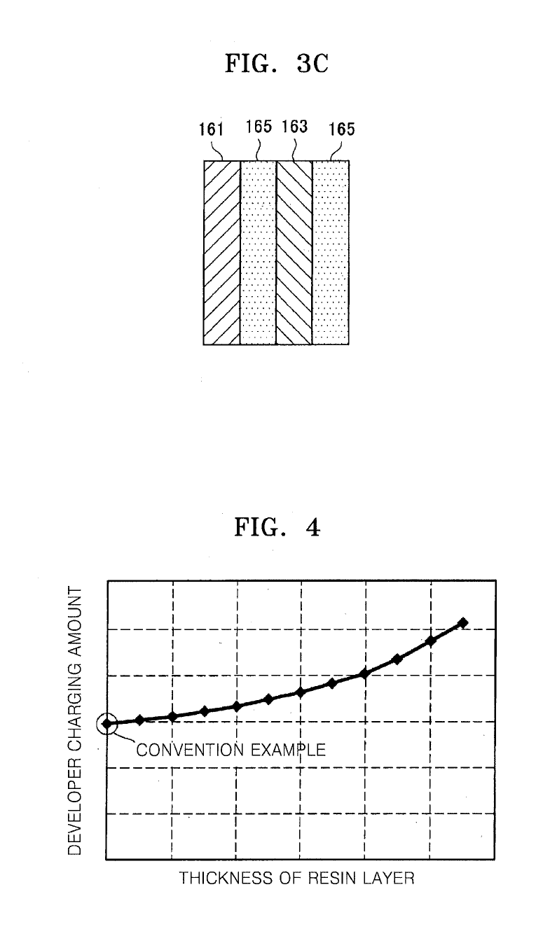

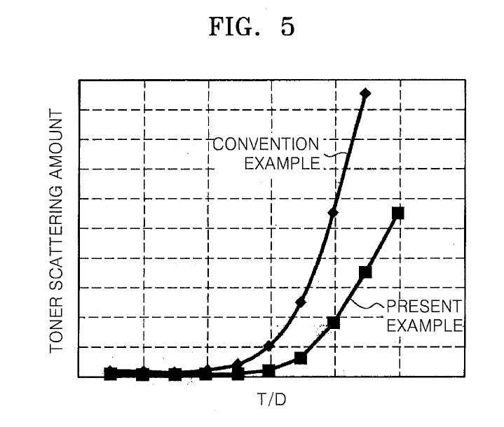

Hereinafter, by referring to FIGS. 4 and 5, the effect of the layer regulator 160 according to the present embodiment will be described in detail. FIG. 4 is a graph of a developer charging amount change with respect to the thickness of the resin layer 165. FIG. 5 is a graph illustrating a relationship between a toner/carrier mixture ratio (T/D) and a toner scattering amount.

FIG. 4 illustrates a charging amount change of a developer when a thickness of a resin layer was changed by using a layer regulator according to the present embodiment. The developer charging amount illustrated in FIG. 4 was evaluated as described below.

A developing unit of which an initial T/D was set at 7% was prepared and 1 g of toner was loaded into the developing unit via a toner supply opening. Thereafter, the developing unit was allowed to idle for over 1 minute and then a developer on an outer circumference surface of a development sleeve was collected and a charging amount (=Q/M: unit:μC/g) thereof was measured by using a field detachment charging amount measurement device (product of DIT Company). These processes were repeatedly performed each time a layer regulator (doctor blade) including a resin layer was replaced with a layer regulator including a resin layer having another thickness and then results were plotted. As a result, it was confirmed that, as illustrated in FIG. 4, compared to a typical layer regulator that does not include a resin layer, the developer charging amount increased in proportion to a thickness of a resin layer. In the present evaluation experiment, a layer regulator having the structure illustrated in FIG. 3B was used.

FIG. 5 shows toner scattering amount results when T/D was changed in a present example in which a layer regulator according to the present embodiment was used and in a conventional example in which a layer regulator in which only a magnetic material was attached to a non-magnetic material (that is, a resin layer is not present) was used. A method of evaluating toner scattering amount results shown in FIG. 5 was evaluated as described below.

To measure the toner scattering amount, T/D of a developer of a developing unit was set at a predetermined value, and a silicon tube (inner diameter: φ4 mm, and outer diameter: φ6 mm) for collecting a scattered toner was installed at three places: at a lower stream side of a rotation direction of a development sleeve, at the ends of a developer transportation area, and at a central point of the developing unit in a lengthwise direction thereof. Then, at a time when the developing unit was driven for 30 seconds, the scattering toner amount was measured using a Dust Trak Model 8520 (suction rate: 1.7 L/min), which is a product of TSI Company. These processes were repeatedly performed each time T/D of the developer varied and an average toner scattering amount at each of the three places with respect to the lengthwise direction of the developing unit was calculated and the results thereof are illustrated in FIG. 5. In the present evaluation, a layer regulator having the structure illustrated in 3B was used.

As illustrated in FIG. 5, in all the evaluation experiments above, when the T/D value increased, that is, an amount of toner increased, a charging amount decreased and thus the toner scattering amount increased. However, in the case in which the layer regulator including the resin layer having the toner charging aiding function according to the present embodiment was used, compared to a conventional example in which the resin layer was not used, the toner scattering amount with respect to the increase in T/D substantially decreased.

As seen from the evaluation results illustrated in FIGS. 4 and 5, the use of a layer regulator according to the present embodiment may contribute to a decrease in a toner scattering amount, as well as the uniform layer thickness regulation. Accordingly, the amount of toner with a relatively low charging level ejected outside the developing unit 100 and contamination inside the developing unit 100 may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A developing device comprising:
a housing for housing a developer that comprises a carrier and a toner;
a development sleeve that is installed rotatably in the housing and is cylindrical; and
a layer regulator installed in the housing in such a way that an end of the layer regulator is spaced apart from an outer circumference surface of the development sleeve,
wherein the layer regulator has a stacked structure comprising a non-magnetic material layer as a substrate, a resin layer for aiding electrifying of the toner by the carrier, and a magnetic material layer for regulating uniformity of the developer.

2. The developing device of claim 1, in which the resin layer comprises a material used to coat a surface of the carrier.

3. The developing device of claim 1, in which the non-magnetic material layer is disposed most downstream among the layers that constitute the layer regulator with respect to a developer transportation direction.

4. The developing device of claim 1, in which the resin layer is disposed most upstream among the layers that constitute the layer regulator with respect to a developer transportation direction.

5. The developing device of claim 1, in which the layer regulator has a three-layer structure comprising the non-magnetic material layer, the magnetic material layer, and the resin layer sequentially disposed in the order stated from downstream to upstream with respect to the developer transportation direction.

6. The developing device of claim 1, in which the layer regulator has a three-layer structure comprising the non-magnetic material layer, the resin layer, and the magnetic material layer sequentially disposed in the order stated from downstream to upstream with respect to the developer transportation direction.

7. The developing device of claim 1, in which the resin layer comprises a first resin layer and a second resin layer, wherein the layer regulator has a four-layer structure comprising the non-magnetic material layer, the first resin layer, the magnetic material layer, and the second resin layer sequentially disposed in the order stated from downstream to upstream with respect to the developer transportation direction.

8. The developing device of claim 1, in which the resin layer has a thickness that is equal to or greater than an average particle size of the carrier.

9. The developing device of claim 1, in which the non-magnetic material layer, the magnetic material layer, and the resin layer are attached to each other by using an adhesive.

10. The developing device of claim 1, in which the non-magnetic material layer is thicker than the magnetic material layer.

11. An image forming apparatus comprising the developing device of claim 1.

12. The developing device of claim 1, wherein the layer regulator is L-shaped.

13. A method of aiding the charging of toner in an image forming apparatus, the method comprising:
installing a developer layer regulator in such a way that an end of the developer layer regulator is spaced apart from an outer circumference surface of a development sleeve,
wherein the layer regulator has a stacked structure comprising a non-magnetic material layer, at least one resin layer, and a magnetic material layer.
